(19) United States
(12) Patent Application Publication
(10) Pub. No.: US 2016/0035024 A1
(43) Pub. Date: Feb. 4, 2016

(54) Initial Margining Using Decayed Scenarios

(71) Applicant: Chicago Mercantile Exchange Inc., Chicago, IL (US)

(72) Inventors: Jingbin Yin, Chicago, IL (US); Jalpan Shah, Chicago, IL (US)

(21) Appl. No.: 14/446,032

(22) Filed: Jul. 29, 2014

(51) Int. Cl. G06Q 40/04

(52) U.S. Cl. CPC G06Q 40/04

(57) ABSTRACT

A margin requirement is determined for a financial product. A present value of the financial position is obtained, and scenario projected values of the financial position at a future date are calculated for a plurality of loss risk scenarios in accordance with a plurality of scenario curves representative of the plurality of loss risk scenarios, respectively. An initial margin requirement is determined based on the obtained present value and the calculated scenario projected values. Each scenario curve of the plurality of scenario curves is configured to forecast the respective loss risk scenario of the plurality of loss risk scenarios as if looking forward from the future date. In some cases, when the financial position includes a swaption that expires before the future date, the swaption is converted to a seasoned swap if the swaption resides in-the-money.

### TECHNICAL FIELD

The following disclosure relates to software, systems and methods for determining margin requirements in a commodities exchange, derivatives exchange or similar business.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price.

Options and futures may be based on more abstract market indicators, such as stock indices, interest rates, futures contracts and other derivatives. An interest rate futures contract, also referred to as an interest rate future, is a futures contract having an underlying instrument/asset that pays interest, for which the parties to the contract are a buyer and a seller agreeing to the future delivery of the interest bearing asset, or a contractually specified substitute. Such a futures contract permits a buyer and seller to lock in the price, or in more general terms the interest rate exposure, of the interest-bearing asset for a future date.

An interest rate swap (“IRS”) is a contractual agreement between two parties, i.e., the counterparties, where one stream of future interest payments is exchanged for another, e.g., a stream of fixed interest rate payments in exchange for a stream of floating interest rate payments, based on a specified principal amount. An IRS contract may be used to limit or manage exposure to fluctuations in interest rates. One common form of IRS contract exchanges a stream of floating interest rate payments on the basis of the 3-month London interbank offered rate for a stream of fixed-rate payments on the basis of the swap's fixed interest rate. Another common form of IRS contract, knows as an overnight index swap, exchanges at its termination a floating rate payment determined by daily compounding of a sequence of floating interest rates on the basis of an overnight interest rate reference (e.g., the US daily effective federal funds rate, or the European Overnight Index Average (EONIA)) over the life of the swap, for a fixed rate payment on the basis of daily compounding of the overnight index swap's fixed interest rate over the life of the swap.

An option on an IRS contract is referred to as a swaption. A swaption permits “synthetic” exposure to the underlying interest rate swap, i.e., without entailing actual ownership of the underlying IRS contract.

Typically, the Exchange provides for a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

The Clearing House of an Exchange clears, settles and guarantees all matched transactions in contracts occurring through the facilities of the Exchange. In addition, the Clearing House establishes and monitors financial requirements for clearing members and conveys certain clearing privileges in conjunction with the relevant exchange markets.

The Clearing House establishes clearing level performance bonds (margins) for all products of the Exchange and establishes minimum performance bond requirements for customers of such products. A performance bond, also referred to as a margin requirement, corresponds with the funds that must be deposited by a customer with his or her broker, by a broker with a clearing member or by a clearing member with the Clearing House, for the purpose of insuring the broker or Clearing House against loss on open futures or options contracts. This is not a part payment on a purchase. The performance bond helps to ensure the financial integrity of brokers, clearing members and the Exchange as a whole. The Performance Bond to Clearing House refers to the minimum dollar deposit, which is required by the Clearing House from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels, i.e. a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

A margin requirement often has two components, an initial margin and a variation margin. In connection with IRS products, for example, the initial margin attempts to cover potential future losses arising from changes in the interest rate. The variation margin captures losses or gains that have already occurred during the pendency of the contract. For example, each party to an IRS trade has incurred losses or gains each day from inception of the contract based on the daily interest rate established by the market. The variation margin thus provides traders with a daily settlement mechanism to account for updates to the payment amount owed under the contract.

### BRIEF DESCRIPTION OF THE DRAWINGS

FIG. 1 depicts a block diagram of an exemplary system for trading IRS contracts or other financial products according to the disclosed embodiments.

FIG. 2A is a block diagram of an exemplary system for determining a margin requirement for an IRS contract or other IRS-based financial product in accordance with one embodiment.

FIG. 2B is a block diagram of another exemplary system for determining a margin requirement for an IRS contract or other IRS-based financial product in accordance with one embodiment.

FIG. 3 is a flow chart diagram of an exemplary method for determining a margin requirement for an IRS contract or other IRS-based financial product in accordance with one embodiment.

FIG. 4 shows an illustrative embodiment of a general computer system for use with the system of FIG. 1 and/or the system of FIG. 2 and/or for implementing the method of FIG. 3.

FIG. 5 is a graphical plot depicting an exemplary base curve for three-month LIBOR IRS contracts used as an input for a margin requirement determination in accordance with one embodiment.

FIG. 6 is a graphical plot depicting an exemplary adjusted scenario curve for three-month LIBOR IRS contracts generated in connection with a margin requirement determination in accordance with one embodiment.

FIG. 7 is a table depicting an adjustment to a scenario curve in accordance with one embodiment.

### DETAILED DESCRIPTION

The disclosed embodiments relate to margin requirement determinations. The margin determinations of the disclosed embodiments provide a more accurate technique for calculating projected values of loss risk scenarios used to determine an initial margin component of the margin requirement. The margining technique is based on configuring a respective discounting curve and a respective forecasting curve for each scenario to forecast a loss risk scenario as if looking forward from a future date relevant to the margin requirement determination. The configuration of the curves effectively decays the curves to take into account the decrease in time to expiration, or expiry, of the financial product presented by valuation as of the future date.

The initial margin component of a margin requirement may be determined in accordance with one or more curves. In each case, a curve is used to compute a forecast return (e.g., a profit and loss, or PnL, computation) for the initial margin requirement determination. The nature of the curve may vary with the type of financial product. For example, the curve may forecast an interest rate, a foreign currency exchange rate, or an equity price, as a function of time. The curve may be adjusted or configured to decay the financial position as described herein.

The disclosed embodiments may be useful in connection with margining interest rate swap (IRS) contracts and other financial products and positions whose market price or conditions are characterized by interest rate curves, such as options on IRS contracts (i.e., swaptions). As discussed above, an IRS contract is a contractual agreement between two parties, i.e., the counterparties of a trade, where one stream of future interest payments is exchanged for another, e.g., a stream of fixed interest rate payments in exchange for a stream of floating interest rate payments, based on a specified principal amount. IRS contracts and swaptions are characterized by two interest rate curves, a forecasting curve and a discounting curve (the “base curves”).

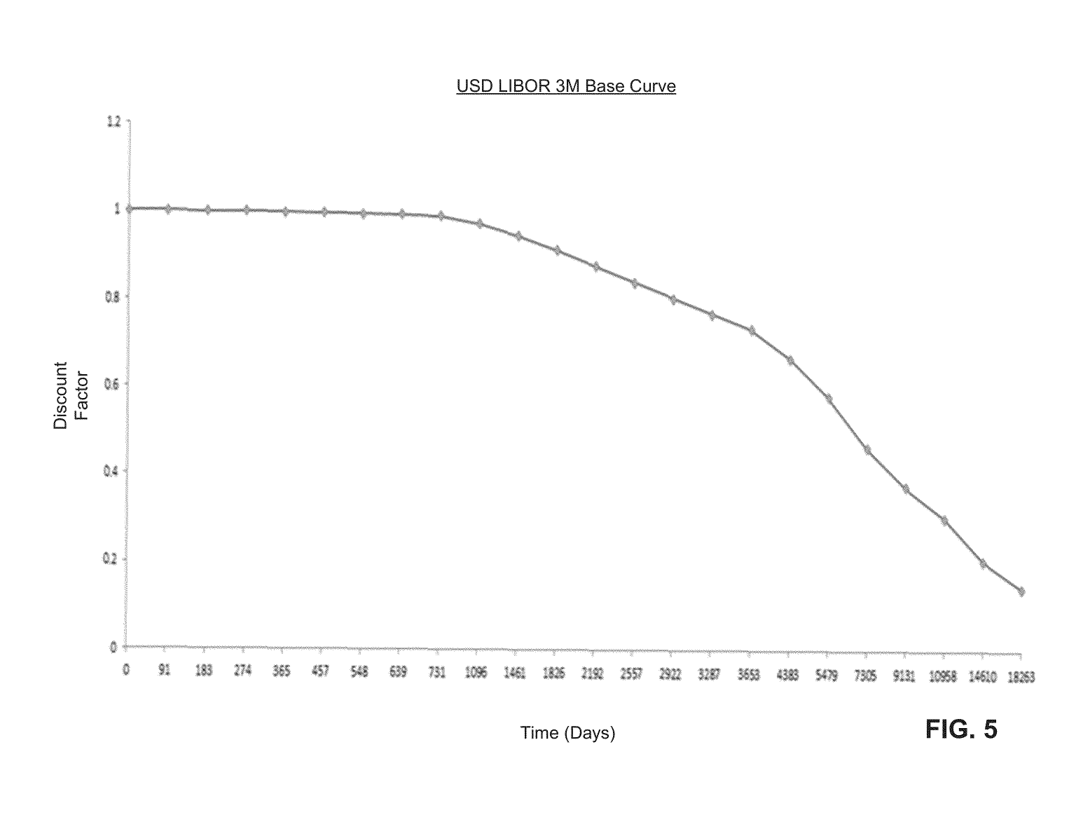

The base curves for an IRS product are defined as today's settlement curves for the IRS product. The settlement curves, in turn, are indicative of the current market price of the IRS product. An example of a base curve is shown in FIG. 5. The base curve of FIG. 5 shows the discount factors used in present value computations, or pricing, IRS positions involving the USD LIBOR 3 month rates.

The discounting curve addresses the time value of money. The present value of the stream of payments, or cash flow, at various points in time may be expressed via a set of discount factors. The set of discount factors is often presented via the discounting curve. In a discounting curve, the discount factors are expressed as a function of time, e.g., days from the present day.

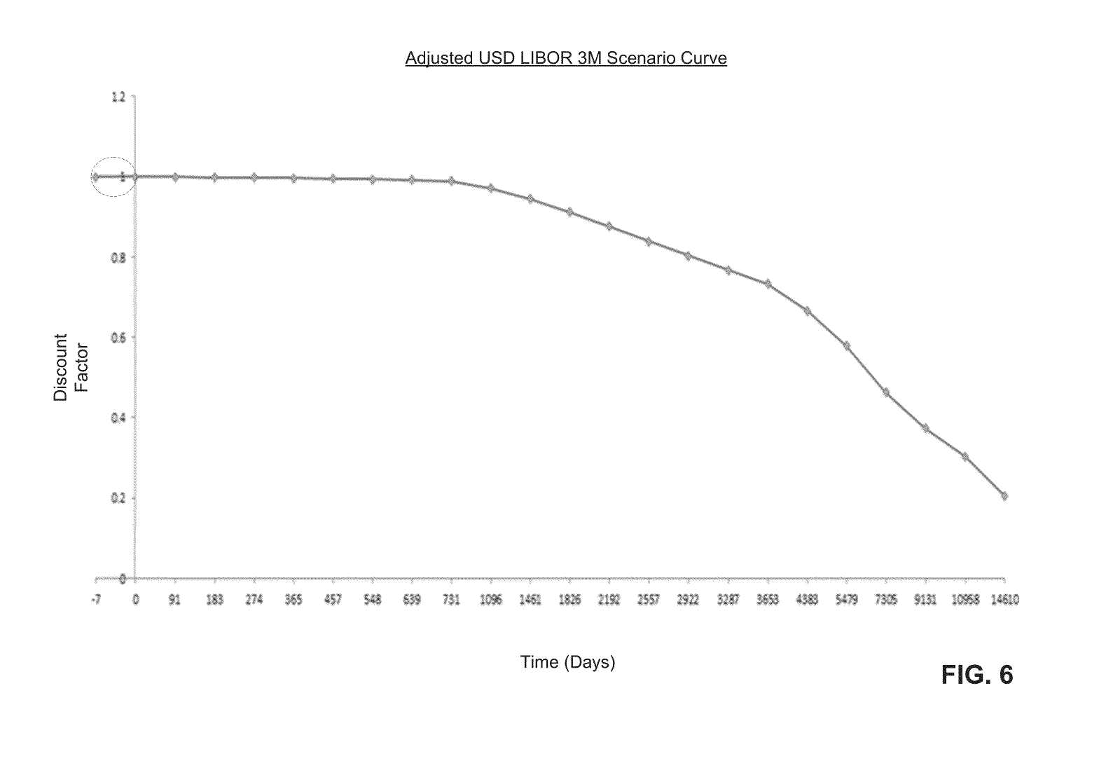

The curve attempts to forecast the future changes in the floating interest rate in the IRS contract. Various scenarios are applied to the financial product to generate scenario curves to be used in the margin requirement determination. An initial margin requirement for an IRS position attempts to cover the possible losses arising from a high percentage (e.g., 99%) of historical market conditions, or scenarios, that give rise to changes to the streams, or cash flows. Each scenario results in, and may be expressed by, modifications to the discounting curve and the forecasting curve for the IRS product. The modified discounting curves and forecasting curves may be referred to as scenario discounting curves and forecasting curves (or scenario curves). An example of a scenario curve is shown in FIG. 6.

The scenario discounting curves and forecasting curves diverge from the base curve over time, reflecting the differences in cash flow amounts and present values. The risk of loss presented by an IRS position for a given scenario equals the difference, on a specified date in the future, between the projected values of the cash flow as indicated by the scenario and base discounting curves and forecasting curves.

In some examples, the future date for purposes of margining IRS positions is five business days. Thus, in such cases, the initial margin requirement for an IRS position attempts to cover the losses accumulated over five business days. The initial margin requirement is set to a value that covers most (e.g., 99%) of the potential five-day returns presented by the loss scenarios. In other examples, time periods other than five business days may be used for the margin period.

The initial margin requirement is updated (or recalculated) and collected periodically (e.g., daily) during the pendency of the contract. The updates reflect changes in the likelihood of future losses or gains as presented by the scenario discounting and forecasting curves generated each day. Calculation of the initial margin requirement involves two price calculations or determinations, namely a current market price (or present value) and a predicted market price on a future date (i.e., the predicted present value of the instrument on that future date). The predicted market price on the future date may be referred to as a “scenario projected value.”

The initial margin determination techniques of the disclosed embodiments are premised upon the recognition that the valuation of an IRS position (or other financial position) is a function of both the discounting curves, forecasting curves, and time (e.g., the time to expiry of the contract). The valuation thus reflects the passage of time and the time value of money, as described above. Accordingly, even with no changes to the base and scenario discounting curves and forecasting curves, the value of an IRS position changes as the time to the cash flow decays with each passing day. As described below, the disclosed embodiments apply this recognition in connection with the computation of the forecast returns at the five-business day point in the future. The scenario discounting curves and forecasting curves may thus be configured to incorporate present value, or time decay, adjustments into the initial margin requirement computations.

The configuration of each scenario discounting curve and forecasting curve is directed to improving the accuracy of the initial margin requirement. The adjustment to the initial margin requirement determination may align the techniques used to determine the initial margin requirement and the variation margin requirement. The variation margin requirement effectively takes into account how the valuation of the income stream of an IRS position is a function of time. The current market price of the IRS position, in theory, reflects the present value of the projected cash flow, or income stream, for the IRS position. Predicting the market price of the IRS position on a future date involves a present value computation as of that future date. That future valuation involves a recognition that the projected income stream changes as a function of time, as the time to the remainder of the income stream of the IRS position changes.

In some cases, the configuration of the scenario discounting curves and forecasting curves is provided via an adjustment to interest rate curves used to forecast the return, or profit and loss (PnL), of the financial product. The interest rate curves may include discounting curves and forecasting curves representative of scenarios used to forecast the risk of loss presented by the financial position. For example, a segment or patch may be incorporated into each scenario curve. The patch may be configured in accordance with a current interest rate curve for the IRS position. The adjusted scenario curve is then used to quantify the risk of loss presented by the scenario. As a result of the adjustment, theta risk (or the risk of time value decay) may be captured or incorporated in the determination of an initial margin requirement determination.

The scenario curves are adjusted because the interest rate fixing (or other market parameter) as of the future date, e.g., the five business day date, is unknown. The interest rate fixing is only known for dates the same as or before the valuation date, i.e., the date on which the initial margin for the IRS is determined. The base curves may be adjusted to include a curve section beyond the section between the present date and the future date.

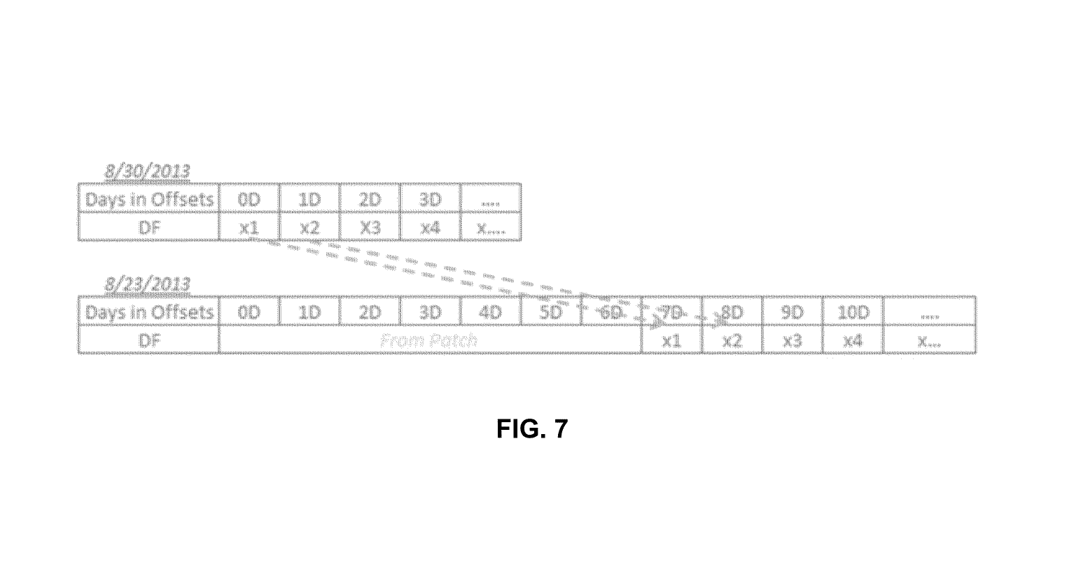

The scenario curve adjustment may include incorporating or adding a segment or patch as a precursor to a remainder of the interest rate curves. The precursor segment provides discount factors for a number of days preceding the valuation date. The preceding days may be expressed as a set of negative dates (e.g., day t-5, day t-4, day t-3, day t-2, and day t-1) if the valuation date is at t=0. The exemplary scenario curve of FIG. 6 includes a precursor segment or patch that extends backward seven days (i.e., five business days) from day zero, the valuation date. Alternatively, the preceding days may begin at t=0, and the valuation date is shifted forward to a positive date, e.g., t=7), as shown and described in connection with FIG. 7.

The scenario curve adjustments or other scenario curve configurations are directed to adjusting the scenario projected value computations, or pricing, of the loss scenarios. The scenario projected values may be calculated for a future date for each loss risk scenario as if looking forward from that future date. The scenario project values may thus reflect the future date on which the risk of loss is evaluated. In this way, the initial margin determination may account for the time-based change, or decay, in the financial position over the five business days. The initial margin determination may thus mimic the change presented via the market and, thus, changes in the variation margin. The initial margin computations may thus mimic the manner in which the variation margin behaves during the pendency of the IRS position.

The initial margin determination may also capture the theta risk of a portfolio including one or more IRS positions, inasmuch as theta risk quantifies the risk of time on a portfolio. For example, capturing the theta risk may be useful in connection with margining swaption positions.

Although described below in connection with examples involving IRS positions based on LIBOR rates, the methods described herein are well suited for determining margin requirements for a variety of interest rate swaps, interest rate-based products, and other over the counter (OTC) financial products, now available or hereafter developed. For example, the disclosed embodiments may be useful in connection with any product using the yield curve for discounting, or otherwise characterized by a yield curve. The parameters of the IRS or other interest rate-based contract may vary from the examples shown. For example, the disclosed methods and systems are not limited to any particular currency, type (e.g., fixed-for-floating, floating-for-floating, fixed-for-fixed, same or different currencies), duration, rate reset arrangement, payment frequency, or other contract parameter.

While the disclosed embodiments are discussed in relation to IRS-related contracts, the disclosed embodiments may be applicable to other financial products, such as bilateral contracts, equity, or other trading system or market now available or later developed. For example, the disclosed embodiments may be useful in connection with various OTC and other financial products that do not have a standardized delivery or settlement date (e.g., a futures contract) where, in contrast, the standardized date allows market prices to already reflect the time decay issue. Examples of such products may involve credit default swaps (CDS), equities, foreign currency exchanges, and other items traded via non-listed contracts.

While the disclosed embodiments may be described in reference to the CME, it will be appreciated that these embodiments are applicable to any Exchange. Such other Exchanges may include a clearing house that, like the CME Clearing House, clears, settles and guarantees all matched transactions in contracts of the Exchange occurring through its facilities. In addition, such clearing houses establish and monitor financial requirements for clearing members and conveys certain clearing privileges in conjunction with the relevant exchange markets.

The disclosed embodiments are also not limited to uses by a clearing house or Exchange for purposes of enforcing a performance bond or margin requirement. For example, a market participant may use the disclosed embodiments in a stress test or other simulation of the performance of a portfolio. In such cases, the margin requirement determination may be useful as an indication of a value at risk rather than a performance bond. The disclosed embodiments may also be used by market participants or other entities to forecast or predict the effects of a prospective position on the margin requirement of the market participant.

The methods and systems described herein may be integrated or otherwise combined with other risk management methods and systems, such as the risk management methods and systems described in U.S. Patent Publication No. 2006/0265296 (“System and Method for Activity Based Margining”), the entire disclosure of which is incorporated by reference. For example, the methods and systems described herein may be configured as a component or module of the risk management systems described in the above-referenced patent publication. Alternatively or additionally, the disclosed methods may generate data to be provided to the systems described in the above-referenced patent publication. For example, the margin requirements determined by the disclosed embodiments may be added to the margin requirement(s) determined by one or more other risk management method or systems.

The margin requirement techniques may be implemented by a distributed computing system. The particular examples identify a specific set of components useful in an exchange, as in an exchange computer system. However, many of the components and inventive features are readily adapted to other electronic trading environments. The specific examples described herein may teach specific protocols and/or interfaces, although it should be understood that the principles involved may be extended to, or applied in, other protocols and interfaces.

The margin requirement determinations described herein may be useful because improvements in the accuracy of the margin requirements may lead to other benefits. More accurate margins may allow traders to devote less capital to margins and instead deploy the capital in further trades. The efficiency and productivity of the exchange computer system may thus be improved. More accurate margins may also lead to a decrease in the frequency of defaults and the computer processing associated therewith. With less defaults to process (e.g., for a given level of trading activity), the computing system may require less processing, memory, storage, and/or other resources. The configuration of the curves via incorporation of a patch or other adjustments may avoid the implementation of resource-intensive algorithms or other algorithms directed to the compatibility of initial and variation margins.

It will be appreciated that the plurality of entities utilizing or involved with the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the Exchange.

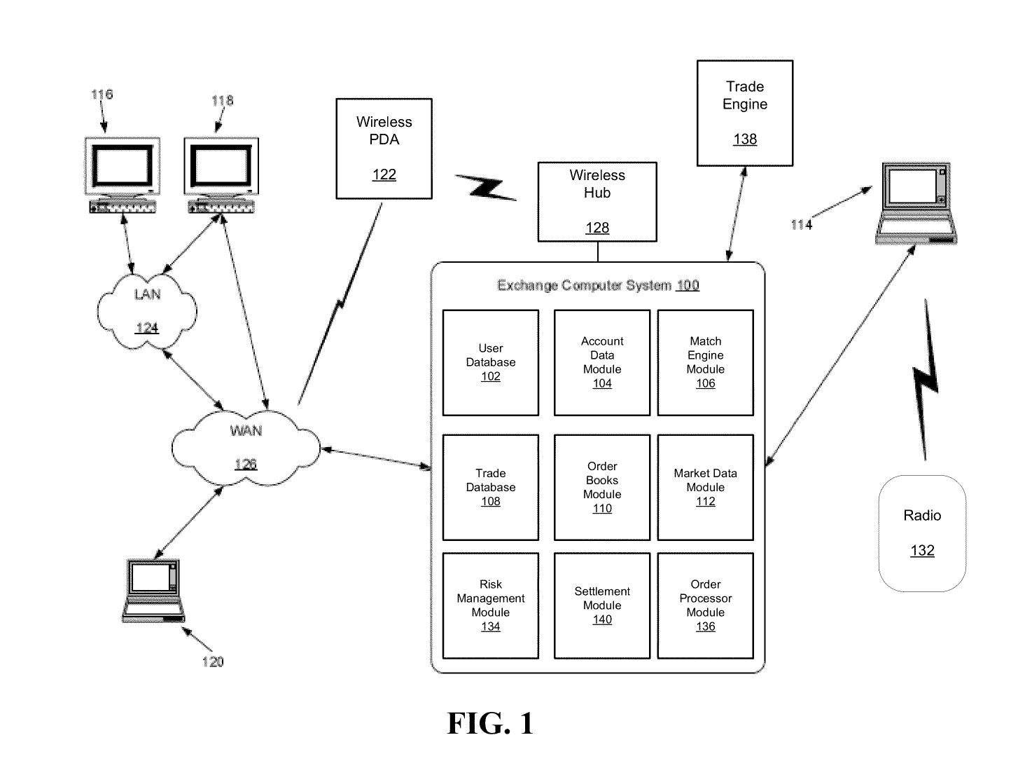

With reference now to the drawing figures, an exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

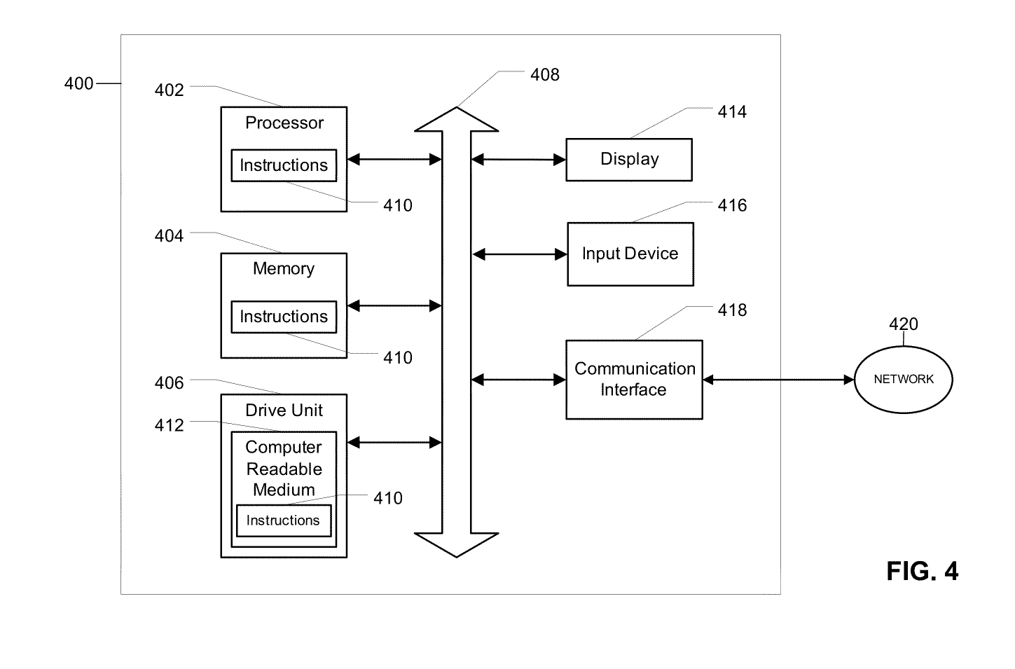

The exchange computer system 100 may be implemented with one or more mainframe, desktop or other computers, such as the computer 400 described below in connection with FIG. 4. A user database 102 may be provided which includes information identifying traders and other users of exchange computer system 100, such as account numbers or identifiers, user names and passwords. An account data module 104 may be provided which may process account information that may be used during trades.

A match engine module 106 may be included to match bid and offer prices and may be implemented with software that executes one or more algorithms for matching bids and offers. The match engine module 106 may be in communication with one or more of the local area network 124, the wide area network 126, or other elements of the exchange computer system 100 to receive data indicative of the orders from the market participants.

A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. The risk management module 134 may also be configured to determine risk assessments or exposure levels in connection with positions held by a market participant.

The risk management module 134 may be configured to administer, manage or maintain one or more margining mechanisms implemented by the exchange computer system 100. Such administration, management or maintenance may include managing a number of database records reflective of margin accounts of the market participants. In some embodiments, the risk management module 134 implements one or more aspects of the disclosed embodiments, including, for instance, scenario curve adjustment, as described below.

An order processing module 136 may be included to decompose delta-based and bulk order types for processing by the order book module 110 and/or the match engine module 106. The order processing module 136 may also be used to implement one or more procedures related to clearing an order.

In the example of FIG. 1, the exchange computer system 100 also includes a settlement module 140 (or settlement processor or other payment processor) to provide one or more functions related to settling or otherwise administering transactions cleared by the Exchange. Settlement-related functions need not be limited to actions or events occurring at the end of a contract term. For instance, in some embodiments, settlement-related functions may include or involve daily or other MTM settlements for margining purposes. For example, the settlement module 140 may be configured to communicate with the trade database 108 (or the memory(ies) on which the trade database 108 is stored) and/or to determine a payment amount based on a spot price, the price of the futures contract or other financial instrument, or other price data, at various times. The determination may be made at one or more points in time during the term of the financial instrument in connection with a margining mechanism. For example, the settlement module 140 may be used to determine a MTM amount on a daily basis during the term of the financial instrument. Such determinations may also be made on a settlement date for the financial instrument for the purposes of final settlement.

In some embodiments, the settlement module 140 may be integrated to any desired extent with one or more of the other modules or processors of the exchange computer system 100. For example, the settlement module 140 and the risk management module 134 may be integrated to any desired extent. In some cases, one or more margining procedures or other aspects of the margining mechanism(s) may be implemented by the settlement module 140.

The exchange computer system 100 may include one or more additional modules or processors, including, for instance, a volume control module configured to, among other things, control the rate of acceptance of mass quote messages. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122, which depict different exemplary methods or media by which a computer device may be coupled with the exchange computer system 100 or by which a user may communicate, e.g. send and receive trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may include a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Numerous additional servers, computers, handheld devices, personal digital assistants, telephones and other devices may also be connected to the exchange computer system 100. Moreover, the topology shown in FIG. 1 is merely an example and that the components shown in FIG. 1 may include other components not shown and be connected by numerous alternative topologies.

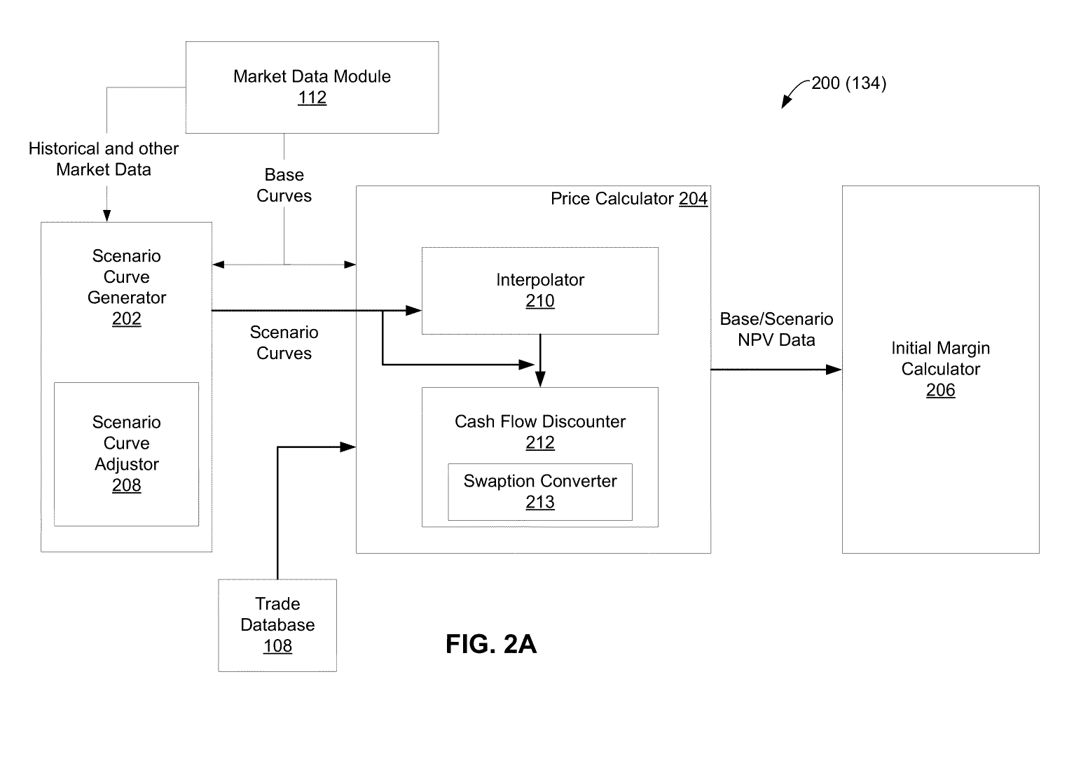

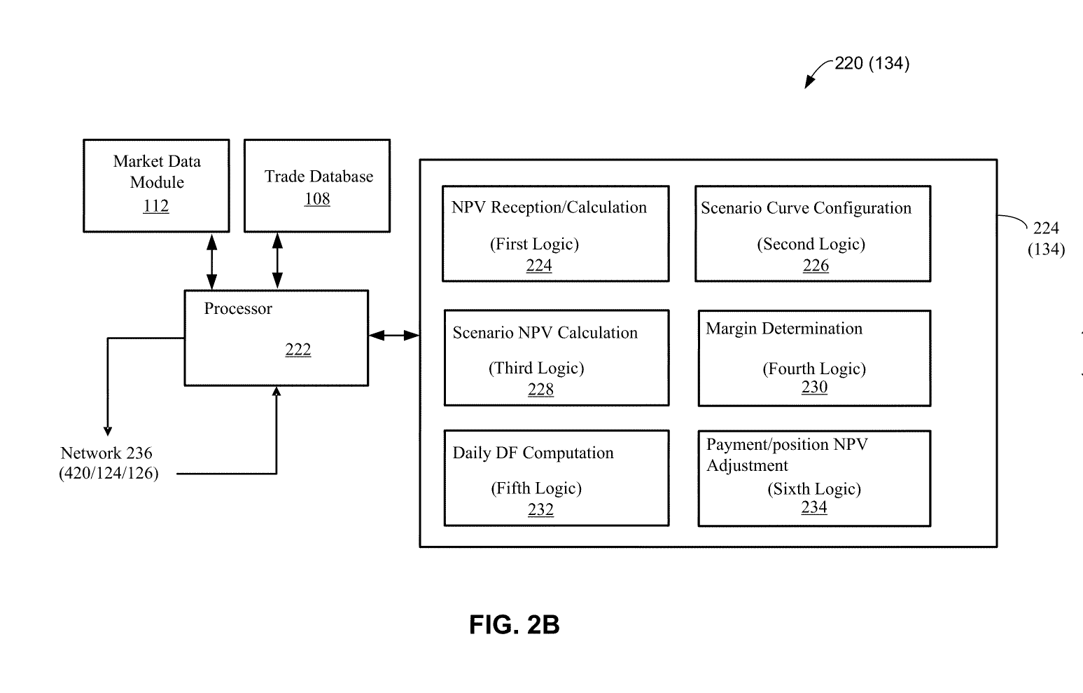

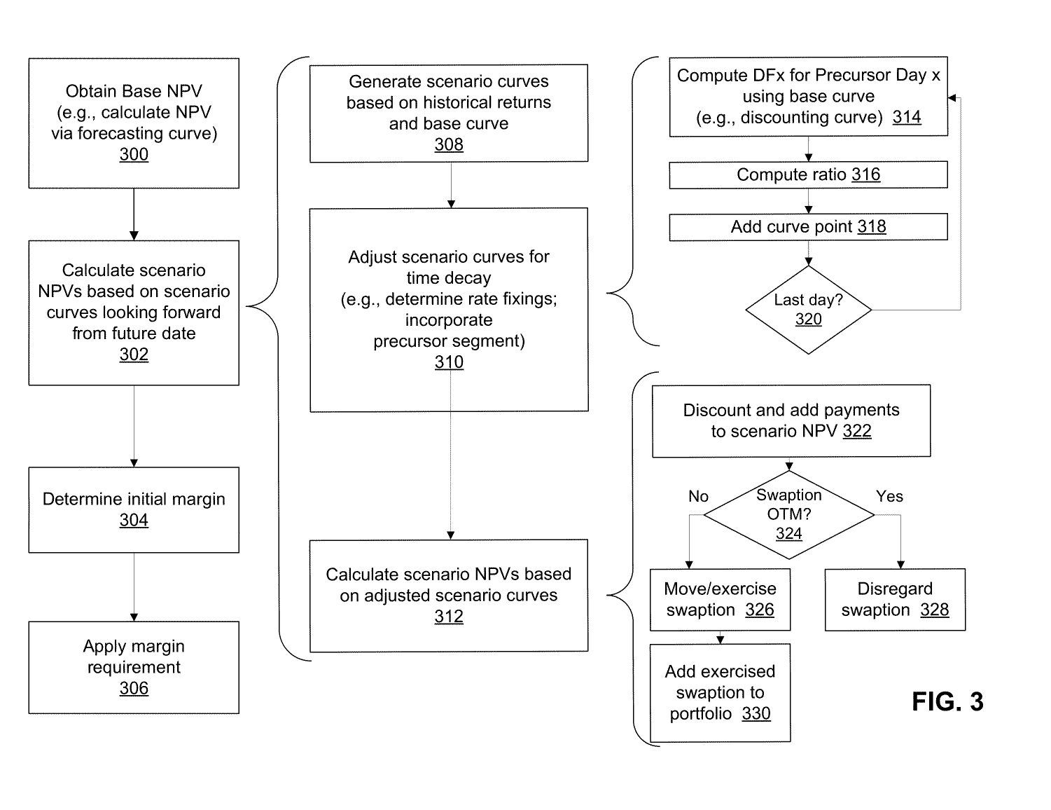

As shown in FIG. 1, the risk management module 134 of the exchange computer system 100 may implement one or more aspects of the margining techniques of the disclosed methods and systems, as will be described with reference to FIGS. 2A, 2B, and 3. It will be appreciated the disclosed embodiments may be implemented as a different or separate module of the exchange computer system 100, or a separate computer system coupled with the exchange computer system 100 so as to have access to margin account record, pricing, and/or other data. As described above, the disclosed embodiments may be implemented as a centrally accessible system or as a distributed system, e.g., where some of the disclosed functions are performed by the computer systems of the market participants.

As an intermediary, the Exchange 108 bears a certain amount of risk in each transaction that takes place. To that end, risk management mechanisms protect the Exchange 108 via the Clearing House. The Clearing House establishes clearing level performance bonds (margins) for all CME products and establishes minimum performance bond requirements for customers of CME products. A performance bond, also referred to as a margin, corresponds with the funds that must be deposited by a customer with his or her broker, by a broker with a clearing member or by a clearing member with the Clearing House, for the purpose of insuring the broker or Clearing House against loss on open futures or options contracts. This is not a part payment on a purchase. The performance bond helps to ensure the financial integrity of brokers, clearing members and the Exchange as a whole. The Performance Bond to Clearing House refers to the minimum dollar deposit required by the Clearing House from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when an IRS position is opened. A drop in funds below this level requires a deposit back to the initial margin levels, i.e. a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

As described below in connection with the exemplary embodiments of FIGS. 2A, 2B, and 3, one or more of the modules of the Exchange computer system 100 may be configured to determine a margin requirement for a financial position. The financial position may be characterized by a curve. The curve may be used to forecast a projected value of the financial position at some future date during the pendency of the contract. The curve may be any curve or other mapping or relationship that provides a characteristic of the financial position as a function of time. The curve may provide a price or value as a function of time. For example, the curve may be a price curve configured to project future prices in connection with an equity or other position. In other cases, other characteristics from which price or value may be derived or determined may be used. For example, an interest rate curve may be used in connection with an IRS contract.

The term “curve” is used herein to refer to any relationship or mapping, and is not limited to graphical representations of the relationship. Curves may present data continuously or discontinuously or discretely.

FIG. 2A depicts a block diagram of a system 200 operative to determine a margin requirement for an IRS or other financial position. In some embodiments, the system 200 may correspond with, or implement, the risk management module 134 and/or another module of the exchange computer system 100. The system 200 may thus be implemented as part of the exchange computer system 100 described above.

One or more of the above-described modules of the Exchange computer system 100 may be used to gather or obtain data to support the margin requirement determination by the system 200. For example, the market data module 112 may be used to receive, access, or otherwise obtain base curve data and other market data, such as historical return data. Market conditions for the financial product may be characterized by a base curve. The nature, content, format, and other characteristics of the base curve may vary with the type of financial product. For instance, the base curve used to price and margin a swaption may vary from the base curve used to price and margin an equity position. The trade database 108 may be used to receive, access, or otherwise obtain data indicative of the current positions within the portfolio of a market participant.

The system 200 includes a scenario curve generator 202, a price calculator 204 (or net present value (NPV) calculator), and an initial margin calculator 206. These components of the system 200 may be integrated to any desired extent. For example, logic used to implement two or more of the components may be integrated within a common module. Additional or alternative components or modules may be included. For example, a separate component may be provided to determine or obtain the NPV of the financial position.

The scenario curve generator 202 receives or obtains base curve data and historical market data from the market data module 112. The scenario curve generator 202 may use such data to generate scenario curves for a number of loss risk scenarios. In one embodiment, the scenario curve generator 202 may be configured to determine the scenario curves through the application of historical scenario log returns to a base curve for the financial position. The nature of the base curve may vary in connection with the type of financial product. For some products, the base curve provides future interest rates as a function of time. For other products, the base curve provides future prices as a function of time. The manner in which data for the base curve is compiled may vary based on the type of financial product.

A variety of techniques may be used to generate the scenario curves from the base curve. For example, the techniques may process the historical market data using a variety of analytical procedures, including, for instance, principal component analysis (PCA). Predetermined scenarios may alternatively or additionally be used.

The scenario curves are used to calculate the NPVs for the loss risk scenarios as of a future date. The scenario forecasting curves are used to project the value of the financial position in each scenario at a future date, e.g., five business days from the current date (or valuation date). The scenario NPVs may thus be referred to as projected values for the loss risk scenarios. To provide an accurate projected value, each scenario forecasting curve is configured to forecast the respective loss risk scenario as if looking forward from the future date. Looking forward from the future date allows the projected value to take into account that the contract is five days closer to expiry. For example, in IRS contract cases, because the valuation date for the loss risk scenarios is moved forward by, e.g., five business days, the rate fixing between the valuation date and the future date is implied for each scenario for the pricing to work accurately. Looking forward from the future date may also allow the projected value to take into account any transfers between the current date and the future date. Examples of calculations of scenario projected values are provided below.

To provide the forecast as of the future date, each scenario curve may incorporate a time-based decay into the scenario projected values. The time-based decay is in accordance with the future date. In some cases, each scenario curve is adjusted to forecast the respective loss risk scenario as of the future date. For example, in IRS contract examples, the adjustment may include determining rate fixings for each date between a current date and the future date for each loss risk scenario. The rate fixings may be based on discount factors derived or implied from the market data, e.g., the base curve or a discount curve. The information used to determine the discount factors may be provided by the market data module 112.

In the embodiment of FIG. 2A, the scenario curve generator 202 includes a scenario curve adjustor 208 to adjust each scenario curve. The scenario curve adjustor 208 may incorporate a precursor segment or other patch into each scenario curve. In some cases, the patch is generated in accordance with the base curve. For example, in an IRS contract, discount factors may be determined based on the base curve for the IRS contract. Discount factors are determined for each business day from a present date up to and including the future date. Points in the patch or precursor segment are then determined based on the determined discount factors.

Set forth below is one example in which the patch is configured in accordance with discount factors implied from the base curve for the financial position.

First, a discount factor DF₅ is computed or otherwise obtained for the fifth business day from the valuation date (the current date, or t) of the base curve. In the three-month USD LIBOR example of FIG. 5, the discount factor DF₅ is 0.99995034677199. Next, compute the ratio of the discount factor DF on the valuation date from the base curve (which is 1) to the discount factor DF₅, or ratio=1/DF5. In the example of FIG. 5, the ratio is computed to be 1.00004965569358. Each scenario curve is then extended to include a point at the fifth business day before the current date (e.g., t-5). The discount factor for the date t-5 is then computed as 1*ratio, where 1 is the original discount factor for the date t-5 from the base curve. The foregoing steps are then implemented for each date between the date t-5 and the current date. In all, the patch then adds five points to the respective scenario curve. The discount factors for the patch may be greater than 1, as shown in the example of FIG. 6.

Once configured with the patch, the scenario curve provides a projected value of the financial position for one of the loss risk scenarios as of, and looking forward from, the future date. The patch allows the initial day (e.g., day 0) of each scenario curve to correspond with the future date rather than the current date. Each scenario curve may thus support a projected valuation as of, and looking forward from, the future date. As a result, in IRS contract cases, for example, the patched scenario curve may then be used to appropriately imply or derive the rate fixings for each loss risk scenario. The patch may thus be constant for all scenarios, but the rate fixing implied from each scenario may still be different due to differences in the unpatched scenario curves. The rate fixings may then be used to calculate the projected values for the loss risk scenarios using the NPV calculator 204.

In the embodiment of FIG. 2A, the NPV calculator 204 includes an interpolator 210 and a cash flow discounter 212. The NPV calculator 204 may be used to calculator the NPV of the financial position and the projected values of each loss risk scenario. The NPV of the financial position may be calculated based on the base curve. The projected value for each loss risk scenario is calculated based on the respective scenario discounting curve and respective forecasting curve generated by the scenario curve generator 202. In other embodiments, the NPV of the financial position is obtained (e.g., from the market data module 112) rather than calculated by the NPV calculator 204. The NPV calculator 204 may include additional, fewer, or alternative components. For example, the interpolator 210 may not be included.

The interpolator 210 may be included to address the discrete nature of scenario curves. Each curve (base and scenario) may specify data for a number of predetermined offset points from the current date. In some IRS examples, each curve may specify an interest rate for day 91, day 183, day 274, day 365, and so on for subsequent years. The interpolator 210 may thus be used to determine further data points for the curves between the offset points.

As shown in FIG. 2A, the adjusted scenario curve data provided by the scenario curve generator 202 may bypass the interpolator 210 if, for instance, the scenario curve (or a portion thereof) is already specified on a daily basis, as in the precursor segment of the adjusted scenario curves.

In the embodiment of FIG. 2A, the NPV calculation is provided by the cash flow discounter 212. In other embodiments, the NPV calculation may be determined in other ways (e.g., in connection with financial positions not involving an IRS contract). The cash flow discounter 212 is configured to calculate the scenario projected value for a specified future date (e.g., five business days in the future) based on the scenario curve data provided by the scenario curve generator 202 for the respective loss risk scenario. The NPV of the financial position may also be calculated by the cash flow discounter 212 in accordance with the base curve.

The initial margin calculator 208 determines an initial margin requirement based on the NPV of the financial position and the calculated scenario projected values. The initial margin calculator 208 may calculate the loss associated with each loss risk scenario by subtracting each scenario projected value from the NPV of the financial position. The manner in which the initial margin is determined from those loss calculations may vary. In some cases, the initial margin is determined in accordance with a 99^{th} percentile standard. In those cases, the initial margin is determined to be an amount that would cover 99% of the loss risk scenarios presented by the adjusted scenario curves. Other percentiles and/or techniques may be used.

The NPV calculation may include a number of other components to improve the accuracy of the initial margin determination. In the embodiment of FIG. 2A, the cash flow discounter 212 includes a swaption converter 213 so that the NPV calculator 204 may appropriately price swaptions and other types of options. The contract details or parameters of the swaptions may be provided by the trade database 108.

The swaption converter 213 is configured to convert in-the-money swaptions to IRS positions. A swaption may be converted to a seasoned swap if the future date used for the scenario NPV calculation is the same or later than the option expiry date and the loss risk scenario results in the swaption residing in-the-money. For example, a payer (call) swaption is executed if the loss risk scenario projects a value greater than the strike value, and a receiver (put) swaption is executed if the loss risk scenario projects a value less than the strike value. For such in-the-money swaptions, the scenario projected value may be calculated for the underlying instrument (e.g., IRS contract).

The swaption converter 213 disregards a swaption that resides out-of-the-money. The scenario projected value for out-of-the-money swaptions is set to zero.

The cash flow discounter 212 may also be configured to incorporate into the NPV data any payments scheduled to occur between the present date and the future date, e.g., during the five business day period. For example, any coupons, premiums, upfront fees, and/or other payments to be paid during the five business day period are incorporated into each scenario projected value. In some cases, the amount to be added to the scenario projected value for the payment is discounted in accordance with one of the discount factors of the patch used to configure the scenario curves.

FIG. 2B depicts a block diagram of a system 220 operative to determine a margin requirement for a financial position, such as an IRS position. In some embodiments, the system 220 may correspond with, or implement, the system 200 of FIG. 2A and/or the risk management module 134 and/or another module of the exchange computer system 100. The system 220 may thus be implemented as part of the exchange computer system 100 described above. One or more of the above-described modules of the Exchange computer system 100 may be used to gather or obtain data to support the margin requirement determination by the system 220.

The system 220 includes a processor 222 and a memory 224 coupled therewith which may be implemented as a processor 402 and memory 404 as described below with respect to FIG. 4. The system 220 further includes first logic 224 stored in the memory 204 and executable by the processor 202 to cause the processor 202 to obtain a present value of the financial position. The present value may be calculated in an NPV calculation based on the base curve for the financial product, as described above. The base curve may correspond with, or may be based on, the settlement curve for the financial product (e.g., IRS product). In some cases, the base curve data is received from the market data module 112. The trade database 108 and/or the market data module 112 may be accessed to obtain the base curve data and/or other data used in the NPV calculation. In other cases, the present value may be obtained from the market data module 112 and/or the trade database 108.

The system 220 further includes second logic 226 stored in the memory 204 and executable by the processor 202 to cause the processor 202 to configure each scenario curve to forecast the respective loss risk scenario of the plurality of loss risk scenarios as if looking forward from the future date. The second logic 226 may cause the processor 202 to generate the scenario curves from the historical return data and the base curve. The second logic 226 may then cause the processor 202 to adjust each scenario curve as described herein. For example, the adjustment may include adding a precursor segment or patch to each scenario curve as described above. In other embodiments, the configuration of the scenario curves is implemented in connection with the generation of the scenario curves. The configuration may thus not involve an adjustment, but rather an initial configuration in accordance with the future date. The scenario curves may be generated in a variety of manners from the base curve and the historical return data. Various margin scenario methodologies may be used. The margin scenario methodology may also vary based on the type of financial product.

The system 200 further includes third logic 228 stored in the memory 204 and executable by the processor 202 to cause the processor 202 to implement NPV calculations. A scenario projected value may be calculated in accordance with the third logic 228 for each loss risk scenario. The scenario projected values may be calculated for the future date established for the margin requirement determination, e.g., five business days from the current date. In some cases (e.g., IRS contracts), the third logic 228 may also cause the processor 202 to calculate the NPV for the financial position. the projected net present value (NPVs) associated with each scenario curve.

The system 200 further includes fourth logic 230 stored in the memory 204 and executable by the processor 202 to cause the processor 202 to determine the initial margin requirement based on the present value obtained for the financial position and further based on the scenario projected values calculated in connection with each loss risk scenario. The initial margin requirement may be determined in accordance with a 99% coverage scheme or any other scheme or technique based on the scenario projected values and the present value of the financial position.

In the embodiment of FIG. 2B, the system 200 further includes fifth logic 232 stored in the memory 204 and executable by the processor 202 to cause the processor 202 to compute a daily discount factor for each date of a precursor segment or patch incorporated into each scenario curve. The fifth logic 232 may be called upon, included within, or otherwise associated with the second logic 226. The daily discount factor may be computed using the discount factor data provided by the base curve, as described herein.

The system 200 may further include sixth logic 234 stored in the memory 204 and executable by the processor 202 to cause the processor 202 to adjust the scenario projected values in accordance with any swaptions and/or payments occurring between the present date and the future date. The sixth logic 234 may be called upon, included within, or otherwise associated with the third logic 228. The sixth logic 234 may be configured to convert any swaption positions that are in the money into IRS positions, as described herein.

Referring to FIG. 3, a computer implemented method is configured in accordance with one embodiment to determine an initial margin requirement for a financial product. The computer-implemented method may be implemented to any desired extent by the system 200 of FIG. 2A, the system 220 of FIG. 2B, the system described in connection with FIG. 4, the processor 202 (FIG. 2B), and/or any other processor or computer system. In some cases, the method is implemented by an exchange computer system. Alternatively, the method is implemented by a market participant or other entity for which the margin requirement may be representative of a value at risk (or potential value at risk).

The order of the steps or acts of the method may vary from the example shown. For example, an NPV of the financial position may be calculated, received, or otherwise obtained after or concurrently with the calculation of scenario projected values. Additional, fewer, or alternative acts may be implemented. For example, application of the margin requirement may not be implemented, or implemented separately from the method.

In the embodiment of FIG. 3, the method begins with obtaining a base NPV for the financial position (block 300) as of the current date (i.e., the valuation date). The base NPV may be received from a module of the exchange computer system (e.g., a market data module). Alternatively, the NPV may be calculated based on other received data, such as a base curve for the financial product.

Scenario projected values (or scenario NPV data) are calculated (block 302) for a future date based on scenario curves for a plurality of loss risk scenarios. Each scenario curve is configured to forecast the respective loss risk scenario as if looking forward from the future date. The scenario curves may be adjusted as described herein. The order of the blocks 300, 302 may vary. The calculations of the blocks 300, 302 may be integrated to any desired extent.

An initial margin requirement is determined (block 304) based on the base and scenario NPV data. For instance, a loss risk value may be computed for each scenario by determining the difference between the base NPV and the scenario NPV. The loss risk values may then be compared to determine an initial margin that covers a predetermined percentage (e.g., 99%) of the loss risk scenarios.

The initial margin requirement may then be applied (block 306). The application of the margin requirement may include crediting or debiting an account of a market participant, generating an alert or other message regarding a margin call or other margin requirement update, and/or incorporating the margin requirement into another margin requirement for a broader portfolio.

Further details regarding an exemplary calculation of the scenario NPV data are shown in FIG. 3. In this embodiment, scenario curve data is generated (block 308) based on historical return data and the base curve. Alternatively, the scenario curve data is generated elsewhere or otherwise available. The scenario curve data is then adjusted (block 310) to incorporate a precursor segment or patch at a beginning of each scenario curve. The scenario NPV data may then be calculated (block 312) based on the adjusted scenario curve data. The manner in which the scenario NPV data is calculated may vary. Another example is described below in connection with FIG. 7.

In the example of FIG. 3, adjustment of the scenario curves includes an iterative procedure configured to produce a discount factor for each day of the precursor segment. The iterative procedure may begin with the computation (block 314) of a discount factor DFx for each precursor day x (e.g., day t-5). The ratio of the discount factor for the current day (the valuation day) and that precursor day is then computed (block 316). The discount factor for the current day is always 1, so the ratio is 1/DFx. A point on the scenario curve is then added (block 318) in accordance with the computed ratio. A decision block 320 then determines whether all of the days of the segment have been addressed and, if not, control returns to the block 314 for the computations for the next precursor day (e.g., day t-4). The iterative procedure is complete once the last precursor day is reached.

In some cases, the calculation of the scenario NPV data includes the discounting and addition (block 322) of any payments occurring between the current date and the future date (e.g., during the five business period). In connection with swaptions or other options that expire within the next five business days (or other margin forecast period), a decision block 324 analyzes the swaption to determine whether the swaption is in or out of the money. If the swaption is in the money, then control passes to a block 326 in which the swaption is exercised for purposes of the initial margin determination. The exercised swaption is added (block 330) to the portfolio for pricing. If the swaption is out of the money, then the swaption is disregarded (block 328), in which the value is set to zero, for purposes of the initial margin determination. For example, a swaption expiring within the five business days is converted to a spot starting swap for all scenarios where the scenario forward is greater than strike for a payer (call) swaption, and for all scenarios where the scenario forward is less than strike for a receiver (put) swaption. In another example, a swaption expiring in one business day is converted to a seasoned swap, e.g., the underlying swap start date is before the valuation date for the scenario case. In some cases, any swaptions expiring outside of the five business day period may be moved up to the date of the fifth business day.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400. The computer system 400 may implement a match engine on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate with a drive unit 406 and other components of the system 400 via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data.

The memory 404 is operable to store instructions 410 executable by the processor 402. The functions, acts or tasks illustrated in the figures or described herein may be performed by the programmed processor 402 executing the instructions 410 stored in the memory 404. The instructions 410 may be loaded or accessed from a computer-readable storage medium 412 in the drive unit 406 or other data storage device. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include an optical or other disk drive unit as the drive unit 406. The disk drive unit 406 may include the computer-readable storage medium 412 in which one or more sets of instructions 410, e.g. software, can be embedded. Further, the instructions 410 may embody one or more of the methods or logic as described herein. In a particular embodiment, the instructions 410 may reside completely, or at least partially, within the memory 404 and/or within the processor 402 during execution by the computer system 400. The memory 404 and the processor 402 also may include computer-readable storage media as discussed above.

The present disclosure contemplates a computer-readable medium that includes instructions 410 or receives and executes instructions 410 responsive to a propagated signal, which may be received via a communication interface 418. The system 400 may be connected to a network 420 to communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus.

While the computer-readable medium is shown to be a single medium, the terms “computer-readable medium” and “computer-readable storage medium” include a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable storage medium may be or include a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The disclosed computer programs (also known as a program, software, software application, script, or code) can be written in any form of programming language, including compiled or interpreted languages. The disclosed computer programs can be deployed in any form, including as a standalone program or as a module, component, subroutine, or other unit suitable for use in a computing environment. Such computer programs do not necessarily correspond to a file in a file system. Such programs can be stored in a portion of a file that holds other programs or data (e.g., one or more scripts stored in a markup language document), in a single file dedicated to the program in question, or in multiple coordinated files (e.g., files that store one or more modules, sub programs, or portions of code). Such computer programs can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor may receive instructions and data from a read only memory or a random access memory or both. The essential elements of a computer are a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Further details regarding the initial margining of IRS positions in accordance with the disclosed embodiments are set forth below in connection with several examples.

FIG. 7 provides an example of an alternative approach to configuring the scenario curves such that the loss risk scenarios are forecast as if looking forward from the future date of the margin forecast period. Rather than change the effective valuation date for each scenario curve (as in the embodiments described above), each scenario curve is adjusted by rolling the scenario curve forward ahead by a number of days between a present date and the future date, and then filling a gap created by the rolling with a respective patch segment. Each patch segment may be determined in accordance with discount factors implied from the base curve, as described above.

In the example of FIG. 7, the current (or valuation) date is Aug. 23, 2013, and the future date for margining valuation is five business days out, or Aug. 30, 2013. The number of calendar days between the two dates is seven. The scenario curve is again configured for valuation on the future date, i.e., Aug. 30, 2013, but the scenario curve may be provided with the forecasted values (in this IRS example, rates or discount factors) shifted to the seventh calendar date 7D). The forecasted values for the first six dates (dates 0D-6D) are then provided via the patch data, which may be calculated as described above. The patch may thus fill the gap created by rolling the curve forward.

When using the rolled curves, any payments occurring within the two valuation dates, e.g., during the five business days, are still happening in the future of the valuation date of the rolled curve. The rolling of the curve may effectively address any payments occurring within the two valuation dates, e.g., during the five business days. Swaptions may be addressed as described above. The swaptions time to expiry needs to be decayed by 5 business days before pricing.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method for determining a margin requirement for a financial position, the computer implemented method comprising:
obtaining a present value of the financial position;
calculating, with a processor, scenario projected values of the financial position at a future date for a plurality of loss risk scenarios in accordance with a plurality of scenario curves representative of the plurality of loss risk scenarios, respectively;
determining, with the processor, an initial margin requirement based on the obtained present value and the calculated scenario projected values;
wherein each scenario curve of the plurality of scenario curves is configured to forecast the respective loss risk scenario of the plurality of loss risk scenarios as if looking forward from the future date.

2. The computer implemented method of claim 1, wherein each scenario curve of the plurality of scenario curves incorporates a time-based decay into the scenario projected values, the time-based decay being in accordance with the future date.

3. The computer implemented method of claim 1, wherein calculating the scenario projected values comprises adjusting each scenario curve of the plurality of scenario curves to forecast the respective loss risk scenario of the plurality of loss risk scenarios as of the future date.

4. The computer implemented method of claim 3, wherein adjusting each scenario curve comprises determining rate fixings for each date between a current date and the future date for each loss risk scenario of the plurality of loss risk scenarios.

5. The computer implemented method of claim 3, wherein adjusting each scenario curve comprises incorporating a precursor segment into each scenario curve of the plurality of scenario curves.

6. The computer implemented method of claim 5, wherein the precursor segment is configured in accordance with discount factors implied from a base curve for the financial position.

7. The computer implemented method of claim 5, wherein the financial position comprises an interest rate swap, and wherein incorporating the precursor segment comprises:
determining discount factors based on a base curve for the interest rate swap; and
determining points of the precursor segment based on the determined discount factors.

8. The computer implemented method of claim 7, wherein determining the discount factors is implemented for each business day from a present date up to and including the future date.

9. The computer implemented method of claim 7, wherein calculating the scenario projected values comprises:
discounting, in accordance with one of the determined discount factors, an amount of a payment to be made between a present date and the future date; and
adjusting the scenario projected values to reflect the discounted amount of the payment.

10. The computer implemented method of claim 1, wherein the financial position comprises a swaption that expires before the future date, and wherein calculating the scenario projected values comprises:
converting the swaption to a seasoned swap if the swaption resides in-the-money; and
disregarding the swaption if the swaption resides out-of-the-money.

11. The computer implemented method of claim 1, wherein calculating the scenario projected values comprises:
rolling each scenario curve ahead by a number of days between a present date and the future date; and
filling a gap created by rolling each scenario curve of the plurality of scenario curves with a respective patch segment, wherein each patch segment is determined in accordance with discount factors implied from a base curve for the financial product.

12. The computer implemented method of claim 1, wherein obtaining the present value comprises calculating the present value in accordance with a base curve.

13. A system for determining a margin requirement for a financial position, the system comprising:
a scenario curve generator configured to generate a plurality of scenario curves representative of a plurality of loss risk scenarios, respectively, for the financial position;
a price calculator configured to calculate scenario projected values of the financial position at a future date in accordance with the plurality of scenario curves; and
an initial margin calculator configured to determine an initial margin requirement based on the calculated scenario projected values and a present value of the financial position;
wherein each scenario curve of the plurality of scenario curves is configured to forecast the respective loss risk scenario of the plurality of loss risk scenarios as if looking forward from the future date.

14. The system of claim 13 wherein the scenario curve generator is further configured to adjust each scenario curve of the plurality of scenario curves to forecast the respective loss risk scenario of the plurality of loss risk scenarios as of the future date.

15. The system of claim 14 wherein the scenario curve generator is further configured to determine rate fixings for each date between a current date and the future date for each loss risk scenario of the plurality of loss risk scenarios.

16. The system of claim 14 wherein the scenario curve generator is further configured to incorporate a precursor segment into each scenario curve of the plurality of scenario curves.

17. A system for determining a margin requirement for a financial position, the system comprising:
a processor:
a memory coupled with the processor;
first logic stored in the memory and executable by the processor to cause the processor to obtain a present value of the financial position;
second logic stored in the memory and executable by the processor to cause the processor to generate a plurality of scenario curves for a plurality of loss risk scenarios, respectively, each scenario curve of the plurality of scenario curves being configured to forecast the respective loss risk scenario of the plurality of loss risk scenarios as if looking forward from a future date;
third logic stored in the memory and executable by the processor to cause the processor to calculate a scenario projected value of the financial position at the future date for each loss risk scenario of the plurality of loss risk scenarios in accordance with the respective scenario curve of the plurality of scenario curves; and
fourth logic stored in the memory and executable by the processor to cause the processor to determine an initial margin requirement based on the obtained present value and the calculated scenario projected values.

18. The system of claim 17 wherein the first logic is further executable by the processor to cause the processor to calculate the present value in accordance with a base curve.

19. The system of claim 17 wherein the second logic is further executable by the processor to cause the processor to roll each scenario curve ahead by a number of days between a present date and the future date, and fill a gap created by the rolling with a respective patch segment.

20. The system of claim 19 wherein each patch segment is determined in accordance with discount factors implied from a base curve for the financial product.
